(19) United States
(12) Patent Application Publication
(10) Pub. No.: US 2021/0237217 A1
(43) Pub. Date: Aug. 5, 2021

(54) Device for holding a bend area of an elongated, flexible element

(71) Applicant: Irritec S.p.A., Capo d'Orlando (ME) (IT)

(72) Inventor: Carmelo Giuffrè, Capo d'Orlando (ME) (IT)

(21) Appl. No.: 16/972,584

(22) PCT Filed: Jun. 10, 2019
(86) PCT No.: PCT/IB2019/054809

§ 371 Date: Dec. 5, 2020

(30) Foreign Application Priority Data
Jun. 14, 2018 (IT) 102018000006297

(51) Int. Cl. B23Q 1/03; B29C 53/08

(52) U.S. Cl. CPC B23Q 1/03; B29C 53/083

(57) ABSTRACT

A device for holding a bend area of an elongated flexible element, such as an electric cable, a rope, a plastic tube or the like has two through-holes placed side by side in a shaped body. At least one of the two holes has a side opening extending to the corresponding peripheral edge of the shaped body, thereby making the hole accessible from the outside.

The present invention concerns a device for holding a bend area of an elongated flexible element, such as an electric cable, a rope, a plastic tube or the like.

In particular, the device for holding a bend area of an elongated element allows to fasten two lengths of said elongated element to one another in a position folded back one on the other so that to form a loop or the like.

A further application generally consists in making a hose-end closing terminal, in particular for irrigation hoses, thanks to the folding of the terminal length of the hose on the immediately preceding length and to the generating of a transverse narrowing of the hose along a bending vertex.

The bending of longitudinal or elongated flexible elements to fold two adjacent lengths of said elongated element back one on the other is carried out for various purposes, such as for example for quickly generating lacing eyes or loops for hooking the elongated element, both in at least one intermediate area with respect to the length of the elongated element and on one or both ends.

In particular, this bending is used to close the ends of the hose in the irrigation field, where flexible plastic hoses are used, to form a narrowing of the tube along the bending line in a bent condition.

Devices for holding an elongated element in the bent condition, which comprise two through-holes placed side by side in a shaped body, are currently known.

Devices of this type are currently known and are formed by two completely-closed circular rings fastened to one another, side by side and forming an “8”-shaped element. The two rings have diameters such as to allow the elongated body to pass, i.e. have a cross section slightly wider or identical to that of the elongated element. This type of devices is installed on the end of an elongated element, for example a cable, a rope or a hose, by inserting a first length of hose, which is provided upstream of a bending line generated by folding a second length of elongated element back against said length upstream of the bending line and by inserting said second length into the second ring, whereas by bringing the two rings at a certain distance from the bending line, the two hose lengths are held in the condition folded back one against the other. It is clear that when the elongated element has a relatively great longitudinal extension, and when the bending is provided in an intermediate area of the length of said elongated element, the application of the currently known device requires sliding the length of the elongated element necessary for bringing the device at a predetermined distance from the bending line and this operation can be long and/or inconvenient, especially when the rope, cable and/or hose are in contact with third elements such as land, mud, etc.

In a specific application, the terminal device is used to sealingly close one or both of the plastic irrigation hose ends, such as for example the irrigation hoses known as driplines or the hoses intended to be used in the construction of irrigation systems of the drip type.

However, a terminal device of the type described at the beginning, as well as the one according to the present invention, is usable in any type of hose which forms a narrowing able to sealingly close the hose when a hose length is bent backwards against an adjacent hose length upstream of the bend area.

The device according to the state of the art effectively holds the terminal length of the hose in the bent condition, wherein the narrowing substantially coinciding with the bending line generates a sealingly closed area of the hose. However, as is clear in the figures, due to the narrowing, the terminal length of the hose assumes a deformed cross section with respect to the circular one and in particular flattened along a direction perpendicular or substantially perpendicular to the bending line or to a diametric plane of the hose substantially parallel to the bending line.

In this condition, the circular hole into which said terminal length is inserted can require that a deformation action be exerted on the hose to compensate for the flattening deformation and to allow an easy insertion into the circular hole.

Moreover, when the bending is used to generate a narrowing to close the hose, the circular hole acts on the hose length in the area near the bending line and thus near the narrowing such as to generate a deformation countering the flattening which leads to the narrowing, thus restoring at least in part the condition in which the cross section is circular, i.e. by possibly moving the opposing walls of the hose, which are in contact with each other along the narrowing, away from one another, thus, when the device is brought too close to the bending line, the at least partial restoring deformation of the circular condition can lead to a widening of the narrowing and thus to a loss of seal thereof.

According to the above, it is clear that the manipulation of the known devices is thus rather complex since the user must keep the hose bent and simultaneously exert a pressure to restore the shape of the circular section of the end of the terminal length which allows to introduce it into the device hole, in addition to making the device already engaged on the length of the elongated element upstream of the narrowing slide towards the end of the opposite length.

Generally, devices of this type are made of plastic, but any material, metal or not, can be used.

The invention thus aims to make a device of the type described at the beginning that overcomes the drawbacks of the known devices, not only allowing to achieve an improved functionality, for example when fastening the sealingly narrowing condition and in avoiding conditions in which the seal can be compromised, but also allowing an easier manipulation when installing the terminal device.

According to a first aspect of the present invention, the device for holding a bend area of an elongated flexible element, such as an electric cable, a rope or a plastic tube or the like, comprises two through-holes placed side by side in a shaped body, and is characterized in that at least one of the two holes has a side opening extending to the corresponding peripheral edge of the shaped body thereby making said hole accessible from the outside, whereby the length of the elongated element is inserted into the first hole upstream of the bending line, whereas the length of the elongated element downstream of the bending line is engaged in the second hole open on the side, by rotating said device around the length of the elongated element through the side opening of said second hole.

In this case, the engagement of the length of the elongated element downstream of the bending line into the second hole does not occur through an axial sliding movement of introduction, but through a radial engagement movement of said second hole and in a sideways direction, i.e. transverse to said elongated element length.

According to a first embodiment variant, only one of the two holes has a side opening.

Instead, an alternative embodiment provides that both holes of the device have a respective side opening.

A further embodiment variant provides that both holes of the device have an opening, but both said openings are provided on opposite sides of the device itself, one with respect to the other.

As far as the shape of the holes is concerned, there are different possible variants.

A first variant provides that one of the two holes has a flattened, oval or substantially elliptical shape, the smaller diameter being substantially oriented with a component in a direction parallel to the direction of alignment of the two holes with each other. Instead, the other hole is circular in shape. In this embodiment variant, it is possible that one or both of the holes have a side opening.

In a variant of the embodiment with a side opening for each hole, these openings are advantageously facing the same side of the terminal device.

An alternative variant provides that both of the holes are flattened, oval or substantially elliptical with the minor axis having at least one directional component parallel to the direction of alignment of the two holes with each other.

Similarly to the embodiment which provides for only one hole shaped flattened, oval or substantially elliptical, also in this case, it is possible to provide for one or both holes having a side opening.

Moreover, according to an advantageous embodiment, the side openings of the holes have side delimiting walls forming pilot surfaces for the insertion of the hose inside them.

Advantageously, the two side walls delimiting the side opening are divergent from one another in an radial outwards direction, whereas they connect to the side edge of the hole in a point of said edge which falls on a secant of said edge such as to generate a narrowing of the opening at the edge which is smaller than the diameter of the hole when it is circular or smaller than the diameter of the hole when it is flattened, oval or substantially elliptical.

In this embodiment, the side opening is provided in the edge area of the opening having the smaller radius of curvature.

Moreover, according to a further embodiment, the device according to the present invention is constituted by two rings or bushings fastened to one another in a position placed side by side and having a predetermined axial extension.

This embodiment confers different aspects to the device depending on one of the embodiment variants previously described and to which reference is made.

For example, the embodiment wherein only one of the holes is open has an “8”-like section, wherein one of the circles is open on the side; the embodiment wherein each of the two holes has a side opening can have an “epsilon”-like section; when the two openings are on opposite sides of the device, then it has an “S”-like section. In all cases, said shapes are the approximative ones, the more general shape having variations in terms of appearance depending on the further different embodiment variants described.

In this case, the thickness of the walls of the two rings or two bushings can be maintained relatively small, thanks to the provision of a stiffening rib and to the calibration of the elastic behavior of the ring.

An embodiment provides that the rib extends along the outer surface of at least one, preferably both of the rings or bushings, on the side opposite the side opening whenever present.

If the ring does not have a side opening, the rib extends along it to a reduced extent with respect to along the ring provided with the side opening.

An embodiment variant can provide a customized body wherein two holes placed side by side and at a predetermined distance are made.

Also in this embodiment variant, it is possible to provide that one or both of the holes are open on the side.

Moreover, also in this embodiment, it is possible that one or both of the holes have one or more of the characteristics described with reference to the previous embodiment.

According to a further alternative, it is possible that both of the holes are made on two elements relatively slidable between one another and alternatively lockable and unlockable in the relative position, thanks to which it is possible to change the distance of the two holes. With reference to a further aspect of the present invention, the terminal device is provided in combination with an elongated flexible element, the holes having sizes corresponding to the diameter of the cross section of said elongated element at least in the not deformed condition with circular section or in the flattened condition with elliptical or oval section, a first length of the elongated element being inserted with one of its ends into one of the two holes and a second adjacent length on the opposite side of the bending line between said two lengths being folded back against said first length, said second length being intended to be engaged in the other hole.

Moreover, according to a further aspect of the invention, the terminal device allows to be coupled with a hose having two hose lengths, respectively upstream and downstream of a bending line, the two lengths being folded back one against the other such as to form a narrowing to sealingly close the port of the hose, thanks to a rotation of the device itself around the hose length upstream from the narrowing. In this case, the closed hole is preventively inserted on the hose from an end, whereas the second hose length is folded backwards such as to generate the narrowing, maintaining the device in a position of non-interference with the path of the terminal length during the folding and said second length being engaged inside the hole open on the side, thanks to a rotation of the device with the opening facing towards the terminal length and through said side opening.

In the embodiment variant wherein both of the holes of the device have side openings, the coupling of the hose to the terminal device occurs after having carried out the bending of the two lengths on both sides of the bending line, by translating along a plane transverse to the axis of the two hose lengths similarly to the method for engaging a fork or the like. However, this variant can also be applied similarly to the variant wherein a hole is completely closed along the delimiting edge thanks to a rotation around the axis of said hole.

A particular application of the device according to the present invention provides that the second hose length downstream of the bending line is a terminal length of said hose and that the bending generates a narrowing for closing the end of the hose.

In addition to the fact of being used to sealingly close a hose, the device according to the present invention can also be used to interrupt the flow in any intermediate point of a flexible hose, for example to carry out maintenance interventions or changes to irrigation systems or the like. In this case, it should be noted that the variant wherein both of the holes have a side opening is advantageous with respect to the other variants which require to insert the hose inside a hole closed on all sides.

In combination with other types of elongated elements, such as cables, ropes or the like, the device according to the present invention can be used to make loops or lacing eyes for hooking of fastening to/with one or both of the ends of said cables, said ropes or the like in intermediate points.

It is important to consider that, in the present description and claims, the term flexible means a behavior of the material of the elastically flexible type, i.e. that in the bending condition, the two lengths separated from the bending line tend to return to the not-bent condition by means of the elasticity or intrinsic resilience of the material.

Moreover, according to an aspect, bending line also means a bend area which can have an extension or length curved according to a radius of curvature.

These and further characteristics and advantages of the present invention will become clearer in the following description of some exemplary embodiments shown in the accompanying drawings, in which:

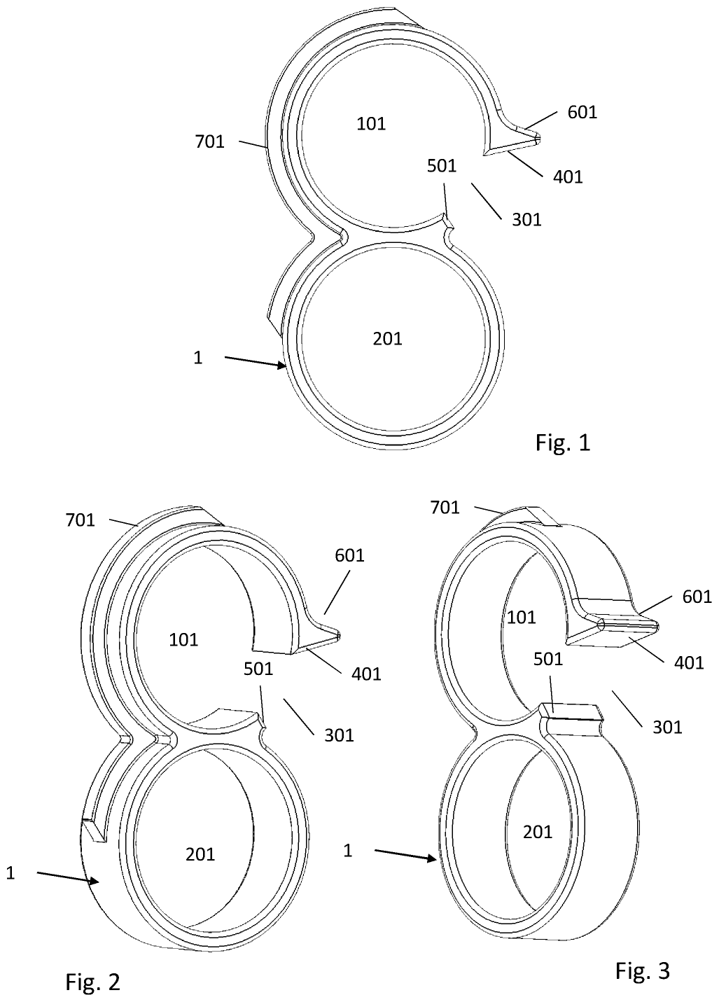

FIGS. 1 to 3 show different views of a first embodiment of the invention.

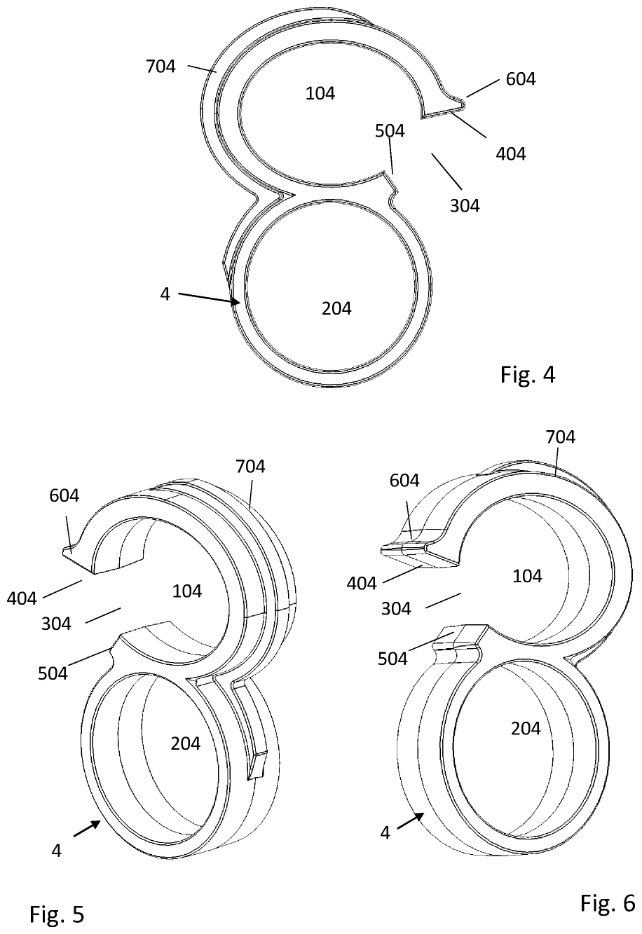

FIGS. 4 to 6 show three views of a second embodiment of the present invention.

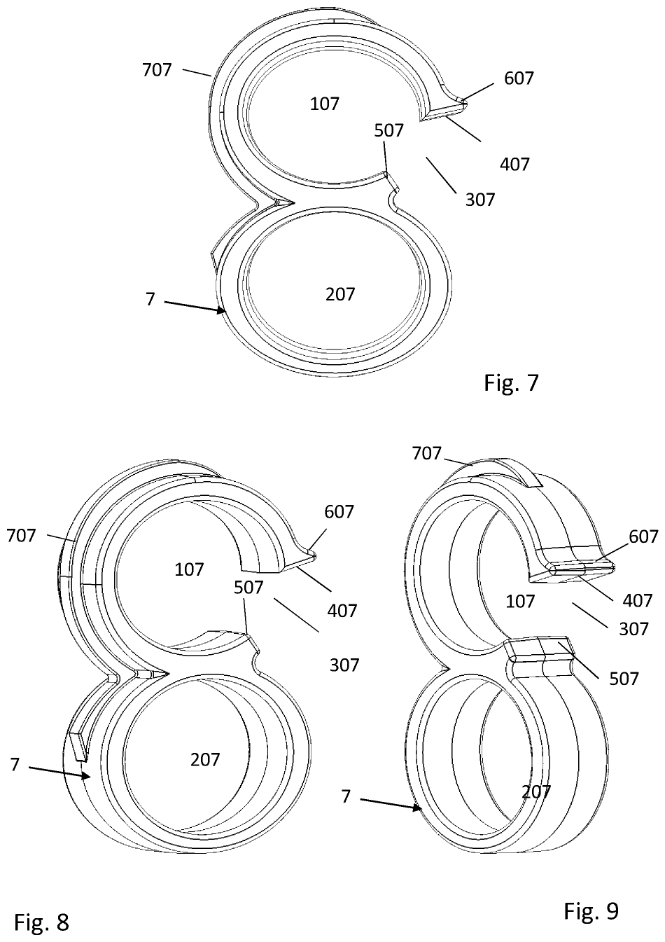

FIGS. 7 to 9 show different views of a third embodiment of the invention.

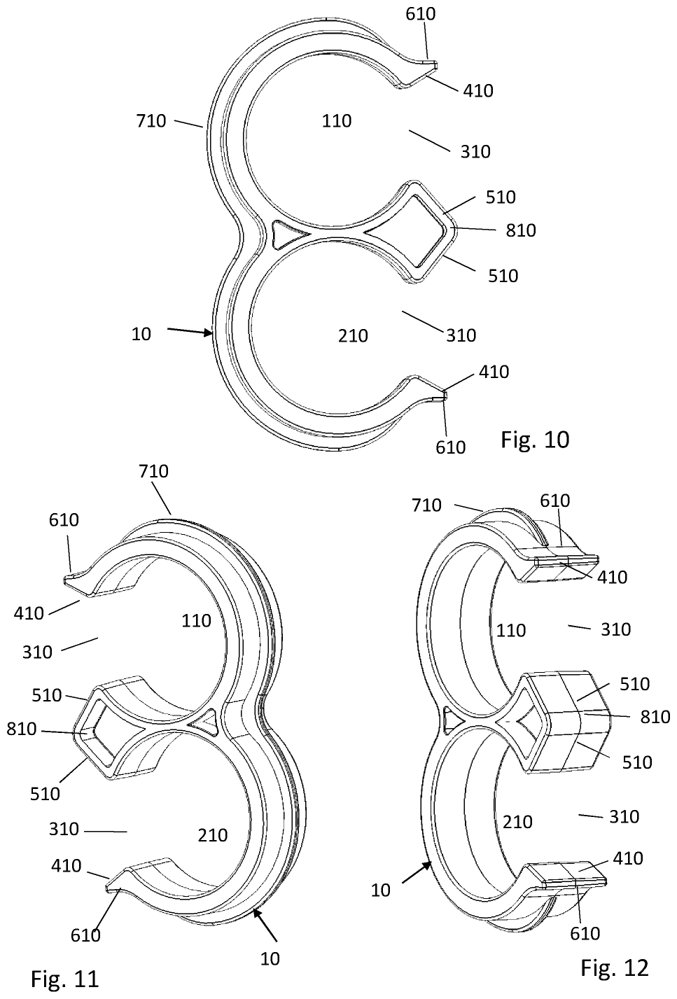

FIGS. 10 to 12 show different views of a fourth embodiment of the present invention.

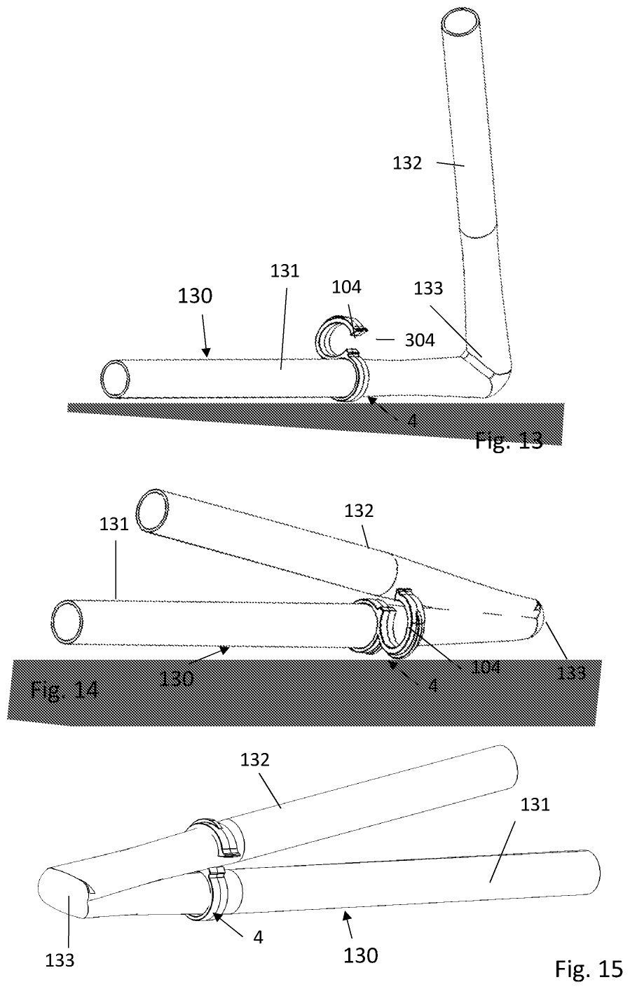

FIGS. 13 to 15 show three steps of the method for closing a hose with a terminal device according to one of the embodiments of FIGS. 1 to 3, or 4 to 6 or 7 to 9.

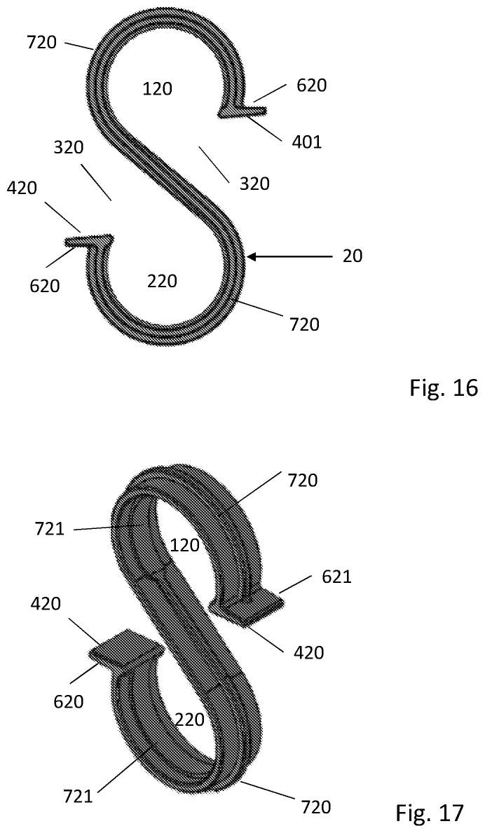

FIG. 16 and FIG. 17 respectively show a plan view and a perspective view of a further embodiment of the device according to the previous invention, wherein it has an “S” shape or an overturned “S” shape.

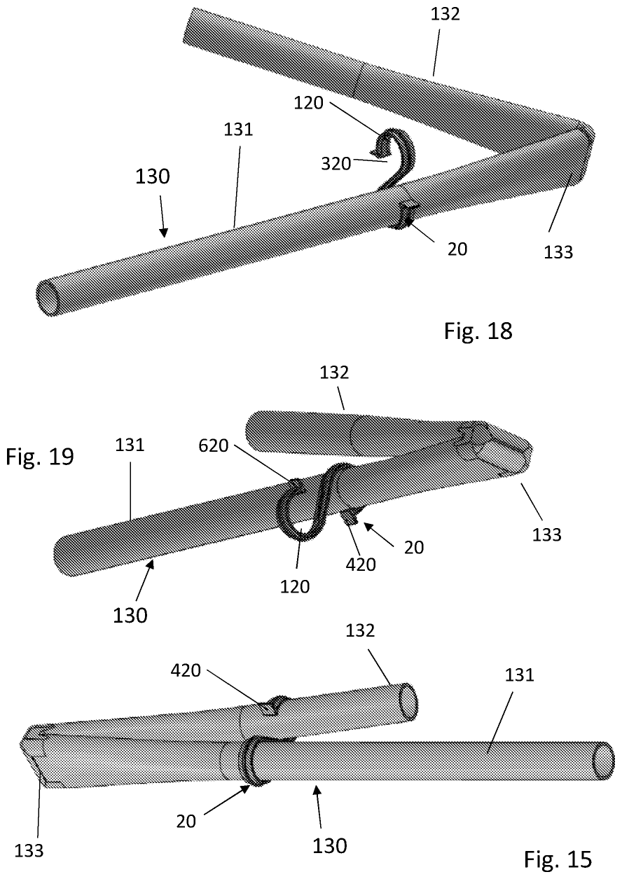

FIGS. 18 to 20 show three steps of the method for closing a hose with a device according to the variant of FIGS. 16 and 17.

Despite the exemplary embodiment described in the following description is intended to be applied to an irrigation hose, for closing it, such application must not be considered limiting the possible applications of the device according to the present invention as already more extensively highlighted above.

With reference to the FIGS. 1 to 3, a first embodiment of the terminal device 1 for closing a hose, in particular, but not limited to, a hose for a drip irrigation system, is constituted by a first couple of rings placed side by side and joined together at a peripheral tangential area, which rings delimit circular holes 101 and 201. A ring 101 is made open on the side.

According to a first embodiment, the opening 301 is provided in an area which is laterally placed side by side of the connecting axis of the centers of the two rings or in alternative to the direction of alignment of the two holes with each other.

The opening 301 has given angular amplitude which is less than 180°, preferably less than 90°.

With reference to the embodiment shown, said opening 301 further extends from the area connecting the wall of the open ring 101 to the wall of the closed ring 201 and by an angle of less than 90°.

The opening is delimited sideways by two opposing side walls 401 and 501 extending inclined in a divergent way in radial outwards direction with respect to the center of the ring.

The inclined surface 501 is made substantially in the thickness of the wall of the ring, whereas the inclined surface 401 extends outwardly beyond the outer surface of the ring delimiting the hole 101, thanks to an extension 601 forming a sort of tooth on the outer side of the opening.

The two walls 401, 501 form a pilot surface for engaging a hose inside the hole 101, which occurs by inserting the hose with a relative movement transverse to the axis of the hose itself.

In particular, as shown in the figures, the two surfaces 501, 401 have different and asymmetrical inclinations with respect to the central axis of the opening and are oriented according to two secants of the edge of the hole 101.

The surface 401 is slightly inclined with respect to a plane perpendicular to the connecting axis of the centers of the holes 101 and 201 or to the direction of alignment of the two rings with each other.

Instead, the side surface 501 delimiting the opening 301 and the pilot surface has a slightly inclined orientation, i.e. convergent towards the connecting axis of the centers of the two holes 101, 201 or of alignment of the rings with each other, in direction of the inside of the hole 101.

The particular arrangement and orientation of the surfaces 401, 501 delimiting the opening 301 favor the engaging action by elastic interlocking a hose in the open hole 101 with a movement transverse to the axis of the hose.

A stiffening rib 701 extends on the side opposed to the peripheral opening 301, along the wall of the two rings and also along the angle area at the length of mutual connection. This rib has the function of calibrating the elastic resistance of the free branch of the wall of the open ring, on the side opposed to the closed ring such as to ensure a sufficient resistance for holding the hose and to simultaneously allow an elastic bending when coupling with the hose.

As is clear in the figures, the stiffening rib 701 extends to a greater extent along the outer surface of the open ring delimiting the hole 101 with respect to the extension along the outer surface of the ring delimiting the hole 201.

FIGS. 4 to 6 show an embodiment variant wherein one of the two rings and the corresponding hole are of non-circular shape, especially flattened in direction of the connecting axis of the centers of the two holes 104, 204.

The term flattened also means an oval or elliptical, regular or irregular, shape.

The device 2 according to this embodiment variant has characteristics substantially identical to those of the variant according to FIGS. 1 to 3. The ring delimiting the flattened hole 104 has an opening 304 which is also delimited by inclined side surfaces 404, 504 forming a pilot surface and which substantially have the same inclinations as those described with respect to the previous exemplary embodiment. The surface 404 is in part constituted by an extension 604 forming a tooth. The stiffening rib 704 is present on the side opposed to the opening 304.

As will become clear in the following description, the flattened shape of the hole 104 and the ring delimiting it is more similar to the section of a terminal hose length, which, having been bent against a previous length, flattened at the bend area, thus flattening and forming a narrowing. Such flattening in the narrowing area progressively becomes wider with the distance from said area until the hose finds its circular section again. Between this point and the narrowing, the section of the hose progressively passes from the flattened shape to the circular shape and assumes flattened-shaped sections in a direction perpendicular to the axis of the bending line. Thus, the flattened hole 104 is better installed with the shape of the hose in a length adjacent to the narrowing.

The flattened shape of the hole 104 also has the advantage of not forcing the hose to assume a circular shape, as it would have when using, for example, the variant of FIGS. 1 to 3, but of letting the hose substantially assume its natural shape caused by the backwards bending. Forcing to assume the cylindrical shape could involve the drawback that the deformation could spread towards the narrowing, thus involving a weakening of the narrowing and leakages.

With regard to the exemplary embodiment, it is possible to provide a variant wherein the flattened shape is given to the hole 204 delimited by the closed ring, whereas the open hole 104 remains circular.

FIGS. 7 to 9 show a further embodiment variant which is different than the one in FIGS. 4 to 6 in that both the rings, and thus the holes 107 and 207 delimited by them, are flattened in direction of the connecting axis of their centers or in direction of the alignment of the rings with each other.

Also in this variant, one of the two rings is open 307 and the opening is delimited by pilot side surfaces 407, 507, one of which is made from an extension 607.

In the same way, the stiffening rib 707 is provided on the side opposed to the opening 307.

FIGS. 10 to 12 show a further embodiment which is different from the previous ones in that the terminal device 10 has both rings and thus holes 110, 210 open. Both the openings 310 are delimited by diverging pilot walls 410, 510 similarly to that which has already been described in other variants. One of these is provided on an extension 610.

In this variant, also the surfaces 510 are provided on an extension which connects the ends of the walls of the two rings closer to each other to one another, forming a sort of laid down V element 810. This element 810 generates a terminal of substantially rhomboidal shape together with the wall lengths of the rings to which it connects.

Also in this case, the stiffening rib 710, which however extends of an equal extent on two rings, is provided on the outer surfaces of the rings.

This embodiment can have rings and thus holes 110 and 210 both of circular shape or both of regular or irregular flattened, oval or elliptical shape or only one of the two holes is flattened, oval or elliptical, whereas the other is circular.

From a functional point of view, the advantage of this variant consists in the method of application, which will be clear hereinafter and also in the fact that the device 10 does not require to be inserted on the hose and slid along it. Thanks to this embodiment, it is possible to use the terminal device also as a narrowing device to apply in an intermediate point of the length of a hose so that to temporarily block the flow, for example for maintenance operations and/or changes to a system.

FIGS. 13 to 15 show different assembling steps of the terminal device on a flexible hose. It should be noted that FIGS. 13 to 15 show the use of the variant according to FIGS. 3 to 6, but the same functionality and operative method is provided for the variant of FIGS. 1 to 3 or FIGS. 7 to 9. Generally, what is shown and described with reference to the FIGS. 13 to 15 is applied to any variant which provides for a device with one closed and one open rings.

As initial step, a hose 130 is inserted in the hole 204 delimited by the closed ring and the device 4 is made to slide for a given length on the hose 130, putting itself in an intermediate position of a terminal hose length 131 and of a length 132 preceding said terminal length. The terminal length 131 of the hose is folded back against the length preceding it 132, forming a narrowing substantially in the area of the bending axis, as denoted by 133. During this operation, the device 4 is rotated sideways with respect to a plane containing the axes of the two lengths 131, 132 and, when the terminal length 131 is brought against the length 132 preceding it, said terminal length 131 is locked in this position, engaging it inside the other open ring. In particular, this occurs thanks to a rotation of the device 4 around the hose length 132 upstream of the narrowing 133. With this rotation, the opening 304 is brought to match the terminal hose length 131 and thus said terminal length 131 is elastically engaged inside the open hole 104.

With regard to that which is described above, it should be noted that an alternative form of installation which provides for the terminal length 131 to be inserted into the closed ring for a given length, so that the device 4 remains upstream of the bending line when said terminal length is folded against the hose length 132 preceding it, is possible. Once the terminal length is brought against the length 132 preceding it, forming the narrowing, said terminal length is hooked with the length 132 upstream of the narrowing 133 by a rotation with which the length 132 upstream of the narrowing 133 is engaged inside the open ring.

In particular, this operative method offers the advantage of being able to bend the two lengths 131 and 132 one against the other and to thus insert the terminal end 131 into the closed ring after the narrowing has been generated.

With reference to the exemplary embodiment of FIGS. 10 to 12, wherein both the rings are open, the coupling of the terminal device 10 occurs by a coupling movement along a plane transverse, preferably perpendicular to the axis of the two lengths 131, 132 after they were brought in the folded one-against-the-other condition.

It is clear that in this case the hose does not have to be inserted into the device 10 before the bending and it is thus also clear that the device 10 can also be used to generate narrowings in intermediate points of a hose.

With reference to the exemplary embodiments shown, they refer to a preferred embodiment which provides for the use of two rings fastened to each other in an “8” shape. However, other forms of the device such as for example a plate having a width greater than the diameter of the holes and a length greater than twice the diameter of the holes, which plate has two holes in a similar position as the one obtained in the embodiments shown, are also possible. One or both of the holes can be open and one or both of the holes can be flattened or oval or elliptical similarly to that which was previously described. In the same way, the openings with the relative pilot surfaces can be provided. The perimeter can be of any shape. The material can also be of any kind.

The embodiment in FIGS. 16 to 20 has an S-shaped section or in alternative an overturned S section.

As shown, the device 20 is formed by two holes 120 and 220 peripherally delimited by two rings which are adjacent to one another and joined in one piece to one another.

Similarly to the embodiment of FIGS. 10 to 12, each ring has an opening 320, but unlike this embodiment, the two openings are arranged on two opposite sides of the device 20. In the embodiment, the two openings are arranged symmetrically with respect to a central axis connecting the centers of the two holes 120, 220, i.e. symmetrical at rotations of 180° with reference to rotational symmetry axis passing through the median point of said axis which connects the centers of the two holes 120 and 220.

Similarly to the previous embodiments, at the opening, the branch interrupted has a pilot surface 420 delimiting the opening 320 and which pilot surface is outwardly prolonged such as to form a grasping fin 620 for a widening of the opening by the manual bending of the branch of the ring.

Always similarly to the preceding embodiments. The embodiment of FIGS. 16 to 20 has a central reinforcing rib 720 extending along the entire length. Considering the particular embodiment, it is clear that the rib 720 is outside of a ring delimiting one of the two holes 120 and 220 and then passes inside the adjacent hole, respectively 220 and 120, thus this length inside the adjacent hole is flattened as shown in FIG. 17 with the length denoted by 721.

The invention claimed is:

1. A device for holding a bend area of an elongated flexible element, the device comprising two through-holes placed side by side in a shaped body,
wherein at least one of the two through-holes has a side opening extending to a corresponding peripheral edge of the shaped body, thereby making the one of the two through-holes accessible from outside.

2. The device according to claim 1, wherein both of the two through-holes have the respective side opening extending to the corresponding peripheral edge of the shaped body making said through-hole accessible from the outside, so as to have two respective side openings, and wherein said side openings are provided either on a same side or on opposite sides of the device.

3. The device according to claim 1, wherein at least one or both of the two through-holes has a circular shape with a predetermined diameter.

4. The device according to claim 1, wherein at least one or both of the two through-holes has an elliptical shape or a shape flattened according to a direction with at least one component parallel to a direction of alignment of the two through-holes with each other.

5. The device according to claim 1, wherein one of the two through-holes is circular and the other one of the two through-holes has an elliptical shape or a shape flattened according to a direction with at least one component parallel to a direction of alignment of the two holes with each other.

6. The device according to claim 5, wherein the through-hole having an elliptical shape or a shape flattened according to the direction with at least one component parallel to the direction of alignment of the two holes with each other is made to be open to a side, and wherein the circular hole is also open to a side or is completely closed.

7. The device according to claim 1, wherein the shaped body is made of two bushings or two rings, which are joined together at a tangential area of a wall of said two bushings or two rings.

8. The device according to claim 7, wherein the two rings or bushings are oriented to have longitudinal axes perpendicular parallel to each other.

9. The device according to claim 7, wherein an outer wall of at least one of the bushings or the two rings or both of the two bushings or the two rings has at least one stiffening rib extending over an amount of length of said outer wall, with a same or a different extent for the two bushings or the two rings.

10. The device according to claim 1, wherein the side opening of one of the two through-holes is delimited by two opposing walls delimiting said side opening on two opposite sides and forming leading walls.

11. The device according to claim 10, wherein the two opposing walls delimiting the side opening are spaced from each other and oriented each according to a secant of said one of the two through-holes, the secants of the two through-holes diverging from each other in a radial outwards direction.

12. The device according to claim 1, wherein the device is provided in combination with a flexible elongated element, the two through-holes having sizes matching a diameter of the flexible elongated element in a non-deformed state defining a circular section or in a flattened condition causing an elliptical or out-of-round cross-section, a first length of the flexible elongated element upstream of a bend zone having one end inserted into one of the two through-holes and a second length of the flexible elongated element downstream of the bend zone being folded back against said first length, so as to make said second length engageable in another one of the two though-holes by rotating said device around the first length of the flexible elongated element and through the side opening of said other one of the two though-holes.

13. A method of closing a hose, in particular for drip irrigation, at an end thereof, using a device according to claim 1, the device comprising the two through-holes that include a first hole fully peripherally closed and a second hole that is open at a side over a predetermined angular amplitude, the method comprising the following steps:
inserting the end of the hose into the first hole that has completely closed sides, sliding the device along the first hole for a predetermined amount;
folding a terminal length of the hose against a length of hose preceding the terminal length, thereby generating a bottleneck in the hose which, at a bend, seals the hose upstream of the terminal length, said terminal length being bent around a bending axis which is substantially parallel to a direction of alignment of the two through-holes with each other; and
engaging the folded terminal length of the hose inside the second hole by rotating the device with the side opening towards said terminal length up to introducing said terminal length inside the second hole.

14. A method of closing a hose, in particular for drip irrigation, at an end thereof, using a device according to claim 1, the device comprising the two though-holes that include a first hole fully peripherally closed and a second hole that is open to a side over a predetermined angular amplitude, the method comprising the following steps:
inserting the end of the hose into the first hole that is completely closed, sliding the device along the first hole for a predetermined amount so that the device is positioned on a terminal length of the hose between the end thereof and a bending line around which the terminal length is intended to be bent along a preceding length of hose;
folding the terminal length of the hose against the preceding length of the hose, thereby generating a bottleneck in the hose which, at a bend, seals the hose upstream of the terminal length, said terminal length being bent around a bending axis which is substantially parallel to a direction of alignment of the two through-holes with each other; and
hooking the folded terminal length to the hose upstream of the bottleneck by engaging a hose length upstream of the bottleneck inside the second hole by rotating the device with the side opening towards said hose length upstream of the bottleneck up to introducing the hose length upstream of the bottleneck inside the second hole.

15. A method of closing a hose, in particular a drip irrigation hose, at an end thereof, using a device according to claim 1, the device comprising the two through-holes that include a first hole and a second hole both open to side over a predetermined angular amplitude on a same side, the method comprising the following steps:
folding a terminal length of the hose against a preceding length of the hose, thereby generating a bottleneck in the hose which, at a bend, seals the hose upstream of the terminal length, said terminal length being bent around a bending axis which is substantially parallel to a direction of alignment of the two through-holes with each other; and
engaging the folded terminal length of the hose and the hose length upstream of the bend respectively inside one of the two through-holes that are open to the side by translating the device against said terminal length and said preceding length according to a direction radial with respect to said terminal length and said preceding length and with the side openings oriented towards said terminal length and said preceding length up to introducing through the corresponding side opening of the terminal length of the hose and the preceding length respectively inside one of the two through-holes.
